(19) United States
(12) Patent Application Publication
(10) Pub. No.: US 2006/0068150 A1
(43) Pub. Date: Mar. 30, 2006

(54) Tribological fiber composite component produced according to the tfp process

(76) Inventors: Martin Henrich, Wetzlar (DE); Marco Ebert, Wetter (DE); Thorsten Scheibel, Bad Nauheim (DE); Roland Weiss, Huttenberg (DE); Dieter Kehr, Biebertal (DE)

Correspondence Address: DENNISON, SCHULTZ, DOUGHERTY & MACDONALD, 1727 KING STREET, SUITE 105, ALEXANDRIA, VA, 22314, US

(21) Appl. No.: 10/516,322

(22) PCT Filed: Jun. 11, 2003
(86) PCT No.: PCT/EP03/06111

§ 371 Date: Feb. 15, 2005

(30) Foreign Application Priority Data
Jun. 11, 2002 (DE) 10225954.2

(51) Int. Cl. B32B 3/02; D04H 13/00

(52) U.S. Cl. 428/64.1; 428/292.1; 428/65.9

(57) ABSTRACT

A tribological fiber composite component especially in the form of a brake disk or clutch disk, having a structure that encompasses at least one TFP preform (60, 62) which is provided with at least one stressable layer of reinforcement fibers. The structure is stabilized by separating material from the gas phase and/or is provided with a monomer and/or a polymer, is hardened and pyrolyzed.

The invention relates to a tribological fiber composite component, in particular in the form of a brake disk or clutch disk.

A fiber composite component in the form of a grid can be found in DE 199 57 906 A1. In the known fiber composite component, it is essentially a grid which has the same or essentially the same material strength or the same or essentially the same fiber volume content in the points of crossing as in the adjacent sections. This results in the advantage that the grid has the same strength over its entire surface.

From the brochure DE. Z.: “Beanspruchungsgerechte Preformen für Faserverbund-Bauteile”, Institut für Polymerforschung Dresden e.V., March 1998, stressable preforms for fiber composite components were proposed which can be produced in Tailored Fiber Placement technology (TFP technology). Reinforcing fibers can be placed on semifinished textile products or films in a great number of patterns with this technology. By repeated stitching, one on top of the other, various material thicknesses are possible. In this way, preforms which can be deep-drawn and/or 3D reinforced can be produced which are embedded in a plastic matrix for further machining to obtain a CFK (carbon reinforced plastic) component by infiltration and hardening.

DE 199 32 274 A1 describes a fiber composite material and a process for producing same. In this case, the fiber composite material contains a duromeric matrix and reinforcing fibers which have a high adhesion to the duromeric matrix in their inner ply and no adhesion in their outer plies. These measures enable the outer area of the CFK fiber composite material to absorb higher stresses than the inner ones.

To produce fiber plastic composite materials in a continuous and component or process-oriented manner, DE 100 05 202 A1 proposes that the fiber bundle be deposited on a plate unit and fixed by seams oriented as desired.

To produce preforms by weaving or stitching is known from the literature US.Z.: BROSLUS, D., CLARKE, S.: Textile Preforming Techniques for Low Cost Structural Composites. In: Advanced Composite Materials New Developments and Applicated Conference Proceedings, Detroit, Mich., USA, Sep. 30-Oct. 3, 1991, in which the preforms can have an anisotropy.

A stressable reinforcing structure is known from DE 197 16 666 A1 which has a basic material consisting of a fabric, fleece or a film with reinforcing fibers extending in a straight or radial or other direction to produce a CFK component.

A CFK fiber composite component for a vehicle floor group is known from DE 196 08 127 A1.

Fiber-reinforced composite components according to U.S. Pat. No. 5,871,604, intended for space travel or aircraft construction, have short fibers in the matrix and longer fibers as reinforcing material.

A process for producing a C/C composite body having an inner layer and a different outer layer is described in EP 0 806 285 B1.

The object of the present invention is to further develop a tribological fiber composite component, in particular in the form of a brake disk or clutch disk, such that it withstands high stresses at low production-related expense. A tribological fiber composite component is also to be provided which can be produced with low waste.

According to the invention, the object is essentially solved by a tribological fiber composite component, in particular in the form of a brake or clutch disk, using at least one structure with at least one TFP preform having a stressable fiber layer, the structure being stabilized by material deposition from the gas phase and/or provided with a monomer and/or polymer, hardened and pyrolyzed, wherein in particular areas of the TFP preform deviate from one another in their fiber volume and/or their layer density and/or their fiber lengths and/or their fiber placement direction.

Instead of using a matrix consisting of at least one monomer and/or polymer and subsequent hardening and pyrolyzation, the structure can also be stabilized by material deposition such as carbon deposition from the gas phase, e.g. by means of CVD (Chemical Vapor Deposition) and/or CVI (Chemical Vapor Infiltration). A SiC or B₄C or Si deposition is also possible. A pre-stabilization by means of e.g. CVI and subsequent infiltration with a monomer and/or polymer with a subsequent hardening and pyrolyzing step is also possible.

According to the invention, a fiber-reinforced carbon or ceramic body such as C/C, C/SiC or CMC (Ceramic Matrix Composite) in the form of a tribological fiber composite component is provided.

In particular, the fiber composite component may consist of a composite consisting of at least one preform and a layer and/or a fabric and/or short fibers and/or felt and/or fleece which consist of carbon or can be converted into carbon or consist of a carbon or a ceramic fiber.

It is also possible to provide a fiber composite component by machining the outer plies or layers, the outer plies or layers of said composite component having the same fiber orientations in the plane of the layer or ply.

To be able to absorb frictional forces to the required degree, it is proposed that the fiber composite component be structured such that short fibers are provided in the outer region. Short fibers are those that have, in particular, an average length of between 1 mm and 20 mm. The short fibers can be applied to the TFP preform, for example, in the form of a loose fill or a fleece. With a loose fill, short fibers are applied, pressed and hardened to a TFP preform in a die.

A further embodiment of the invention provides that the TFP preform be provided with integrally formed openings and/or channels which are stabilized during the compacting with cores which are lost or not lost or are contained in the desired form. Similarly formed channels can be used as cooling channels.

The fiber composite component may also be composed of several one-piece preforms which are stitched together.

To obtain a three-dimensional reinforcement, reinforcing fibers such as e.g. carbon fibers, can be stitched together with the preform, the proportion thereof can be between 1% and 40% of the total fibers, in particular in the range of between 5% and 20% of the total fibers.

It is also possible to produce the fiber composite component out of one or more preforms and/or to use rovings with different thread counts. Rovings of varying lengths and/or surface extension can also be used.

In particular, the invention is essentially distinguished in that the structure has at least two TFP preforms which are constructed preferably the same or substantially the same. Optionally, the structure can have recesses and/or channels provided with cores, the recesses and/or channels being defined by webs which are also formed as TFP preforms, the reinforcing fibers preferably being placed so as to cross one another, preferably at an angle of 45°.

The reinforcing fibers in the TFP preform, which can consist of one or more layers arranged above one another, should be placed, in particular, in such a way that, with a circular disk-like form, the pyrolyzed preform corresponds to or to a large extent corresponds to the preform in its radial dimensions.

The reinforcing fibers of the individual layers or plies are, in turn, stitched together with the base layer, which can be formed on a carbon base, aramide and/or ceramic fiber base and/or polymer fiber base.

Even when the fundamental aim is to use a single TFP preform of sufficient thickness in some tribological bodies, such as a clutch disk, the structure can also comprise two or more TFP preforms which should essentially have the same or substantially the same construction.

If a TFP preform has more than one ply or layer, the number or design should be selected in such a way that a mirror-image structure of the TFP preform, in particular with respect to its central symmetry, is produced to eliminate warping or a distortion in the finished component.

If several plies or layers are used, at least some of them should have fiber orientation that differ from one another in the plane of the layer or ply. Thus, e.g. the fibers can be placed radially in the inner layers which adjoin the central symmetrical plane, whereas the adjoining layers have fibers which are placed e.g. in a circular manner. An involute pattern or a tangential pattern is also feasible. In this case, a tangential pattern is one in which the fibers extend tangentially of a central internal opening of the preform.

In a structure of a brake disk, it is provided that least two TFP preforms spaced from one another are connected by webs formed from reinforcing fibers.

In particular, it is provided that a TFP preform has, in that area in which force is introduced, e.g. by a screw, a bolt or a gearing, a thickening which contains reinforcing fibers. The reinforcing fibers can be placed e.g. crossing one another in the thickening.

Independently hereof, a further embodiment of the invention provides that certain TFP preforms have a fleece layer in their free outer surfaces, in particular, for a brake disk.

Further details, advantages and features of the invention can be found not only in the claims, the features found therein—alone and/or in combination—but also in the following description of examples of embodiments found in the drawings, in which:—

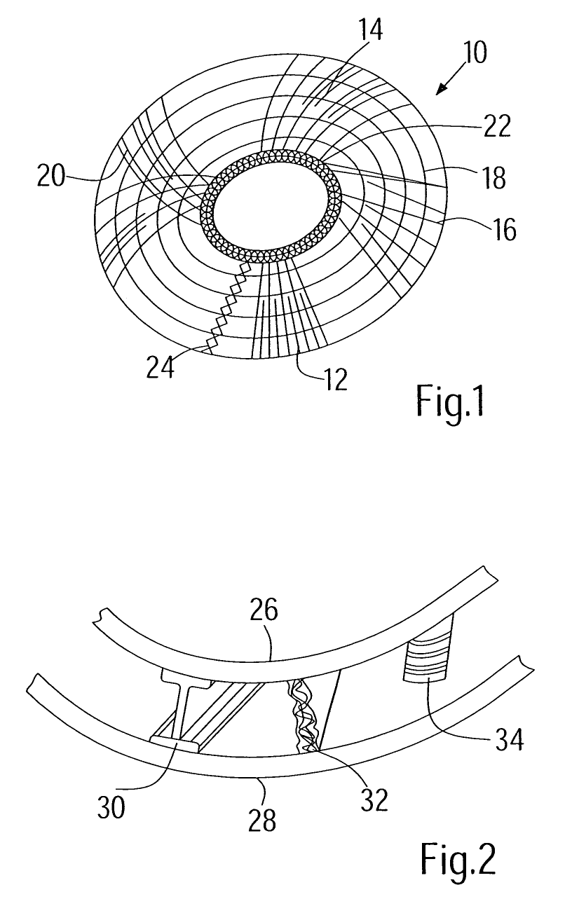

FIG. 1 shows a basic representation of a preform intended for a clutch disk,

FIG. 2 shows a 3D structure produced from preforms and intended for a brake disk,

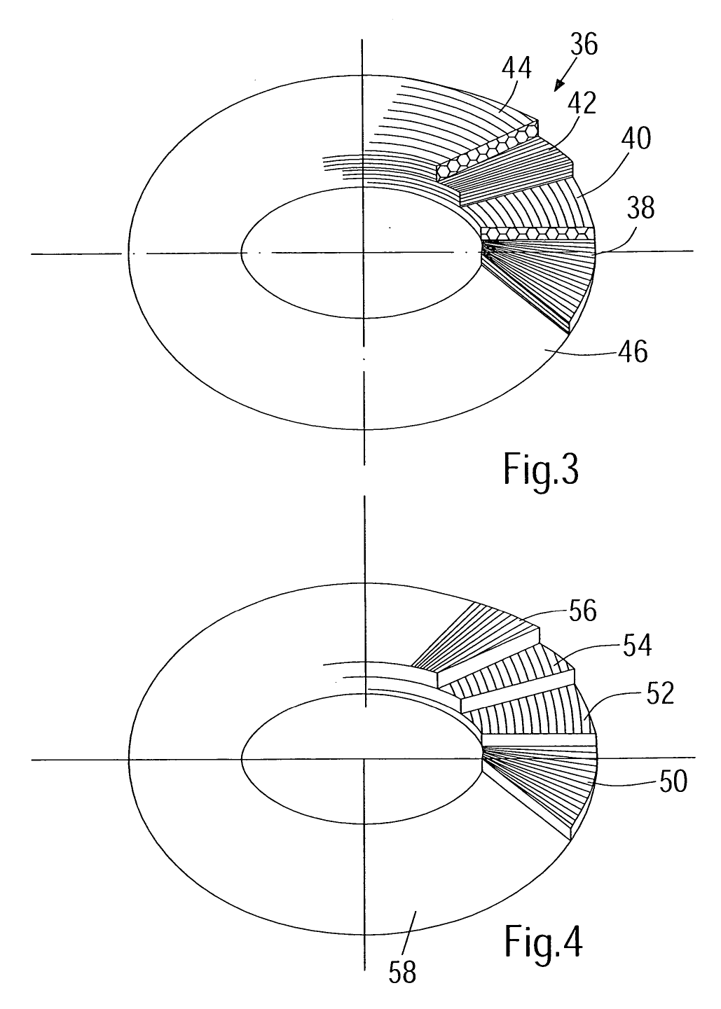

FIG. 3 shows a basic representation of a preform intended for a clutch disk,

FIG. 4 shows a basic representation of a preform intended for a brake disk,

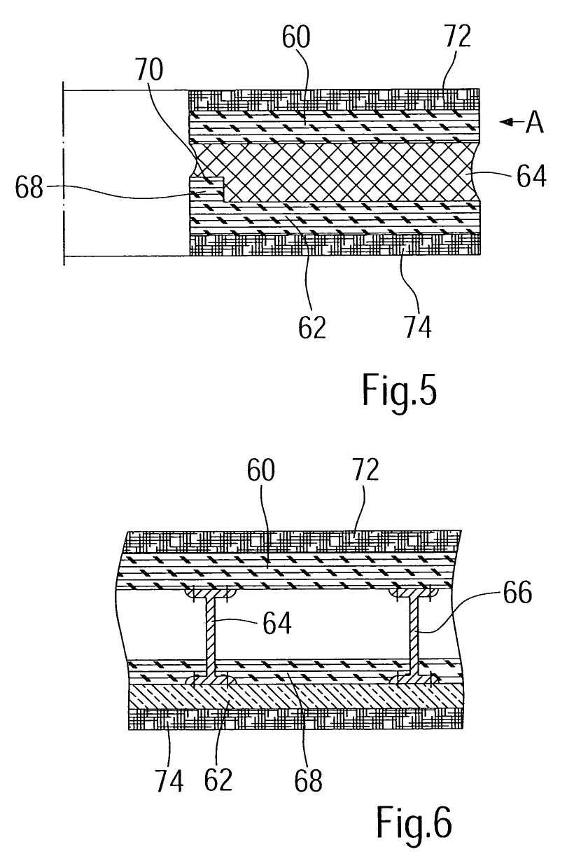

FIG. 5 shows a transverse section through a structure composed of several preforms intended for a brake disk, and

FIG. 6 shows the structure of FIG. 5 in view A, and

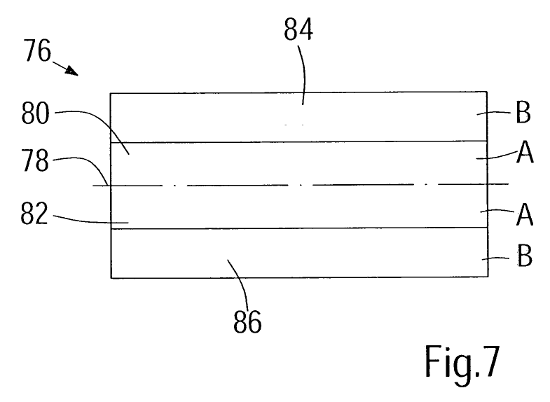

FIG. 7 shows a basic structure of a TFP preform which consists of several layers or plies.

In the figures, preforms from which a fiber composite component in the form of a brake or clutch disk is produced are shown purely by way of example. To this end, the preform, to be described in greater detail in the following, is brought into a form, hardened under pressure during simultaneous heat treatment and then carbonized at a temperature of e.g. 500° C. to 1450° C., in particular in the range of between 900° C. and 1200° C., and then optionally graphitized at a temperature of between 500° C. and 3000° C., in particular in the range of between 1800° C. and 2500° C.

Independently hereof, it is provided that the structure be siliconized after the pyrolysis, optionally after a first machining, whereby in particular a capillary process is carried out a temperature in a range of about 1450° C. and 1850° C.

The preform itself can be impregnated with a monomer or in particular polymers, such as resin, prior to or after insertion into the mold. Instead of and in addition to the monomers or polymers, thermoplastic polymer fibers can also be used to form the matrix.

The preform itself is produced according to the Tailored-Fiber-Placement technology (TOP technology). For this purpose, fibers a re stitched onto a base material such as a semifinished textile product or film, the fibers to be stitched together consisting of or containing reinforcing fibers to the desired extent. Roving strands or fiber bands of natural, glass, aramide, carbon or ceramic fibers, to name only a few by way of example, are used as reinforcing fibers. To ensure that the fiber composite body produced from one or more preforms has a stressable phase orientation, the fibers or fiber strands which are stitched together to form the preform can have the desired orientation.

The basic material, also called base layer, consists in particular of a carbon base, but it can also consist of aramide and/or ceramic fibers and/or plastic fibers.

If several layers or plies of reinforcing fibers are applied to a corresponding base layer, then they are basically each stitched together with the base layer. Polymer threads or carbon threads are suitable as stitching threads. The latter are then preferably selected when the TFP preform or the component made therefrom is required to have a desired heat conductivity in direction of thickness of the component.

With respect to the base layer, it should be noted that it can remain stitched together with the individual layers or plies during further machining of the preform. However, it is also possible that the base layer is removed prior to the further treatment.

Thus, in a TOP preform 10 according to FIG. 1, it is provided that reinforcing fibers extend radially (fibers 12), involutely (fibers 14) or tangentially (fibers 16), the basic structure of the TOP preform 10 being formed by fibers 16 extending in a spiral or circular manner. It is also possible that involutely extending fibers cross one another (area 20) in order to vary the fiber volume content or layer thickness over the TOP preform 10 to the desired extent, as a result of which the desired stress-oriented design of the TOP preform 10 is ensured.

Centrifugal forces can be absorbed by means of the radially extending fibers 12 and frictional forces by means of the tangentially extending fibers 16. The involutely extending fibers 14, 20 are aligned to both the centrifugal forces and frictional forces.

Centrally, the TFP preform 10 can be made with additional reinforcements which can be formed by a high fiber density or a high fiber volume content. Additional web structures (area 24) can also be formed.

The areas 22, 24 having the desired structures are stitched together with the base material of the TFP preform 10 or with the available fibers by means of a suitable stitching technique.

In FIG. 2, two TFP preforms 26, 28 are connected to one another by webs 30, 32, 34 having the desired geometry, whereby the TFP preforms 26, 28 can be regionally varied in their fiber volumes, layer densities and/or in the lengths of the fibers used, in accordance witht eh preceeding description, in order to obtain the stress-specific properties.

The webs 30, 32, 34 themselves are also preforms which, however, do not necessarily have to be produced according to the TFP technology, but preferably should be.

With reference to FIGS. 3 to 6, further features of the invention to be highlighted are to be described. Procedural steps of the invention to be highlighted for producing tribological components such as clutch and/or brake disks can also be found.

In FIG. 3, a preform 36 is shown which consists of several layers or plies 38, 40, 42, 44. The first layer 38, which can be used during the further machining or which however can be removed, is thereby applied, e.g. stitched, onto a base layer 46 in a known manner. The base layer can be e.g. a fabric, a fleece or the like. The first ply or layer 38 which is placed on the base layer 46 has a radial pattern of fibers. The second layer or ply 30 exhibits a circular arrangement of fibers. The third layer 32 comprises a radial pattern and the fourth layer 44 a circular pattern of fibers. The laying of the carbon fibers was thereby selected in such a manner that a balanced and uniform distribution occurs over the entire circular surface of the layers or plies 38 and 42, even with a radial orientation of the fibers.

The dimensions of the preform 36 amount to about 145 mm for an outside diameter and about 60 mm for an inside diameter (hole). The thickness can be about 2.8 mm.

Similarly constructed preforms 36, namely three corresponding TFP preforms 36, are then impregnated with a phenolic resin system in a vacuum process. The subsequent compacting of the three preforms 36 to form a green body was carried out by means of a hot press at a pressure of e.g. 14 bar and at a temperature of about 130° C. The hardened resin is converted into carbon in a pyrolysis process at about 1200° C.

The C/C body thus produced has a density of about 1.38 g/cm³ with a porosity of about 24%. During the pyrolysis, the component shrinks in direction of thickness from the green body measurement 6.9 mm to the measurement 6.15 mm. Due to the fiber arrangement, the measurements of the inside diameter and outside diameter remain the same.

The C/C body is pre-machined to the dimension 147 mm×64 mm×5.2 mm prior to the final siliconizing. Precise machining of the later friction surfaces should hereby be taken into consideration, so that the circular fiber orientation has an effect on both sides of the disk. The siliconizing takes place by means of a capillary process at temperatures of up to 1,700° C.

The silicon absorption during conversion into a C/C-SiC material amounted to 75% by weight. The material now shows a density of 2.03 g/cm³ with an open porosity of 2.5%.

The last machining step is the finishing process and the application of the fastening bores. Since a conventional mechanical testing is unsuitable due to the special fiber orientation, centrifugal tests were performed.

With a fixed and play-free mounting at four receiving bores on the inner diameter, a rupture speed of rotation of 26,700/revs. per min. was attained. The rupture occurred at the recessed bores.

Comparative studies with a fabric-based disk of the same dimensions show a rupture speed of rotation of 19,500 revs. per min. FE (Finite Elements) analyses also show a clear balanced distribution of stress and distortion under stress.

The advantages obtained are, in addition to the higher stress capacity, also the definitely lower waste during production. The structural stability during production makes it possible to produce a near-net shape. Furthermore, it is possible to vary the fiber orientation in the friction area for the tribological properties.

A clutch disk thus produced, which consists of three preforms, each of which is similarly constructed as can be seen in FIG. 3, has final measurements of 145 mm×60 mm×2.8 mm. The preforms are thereby arranged above one another to form the greenling in such a way that the outer layers have a circular fiber orientation after the finishing process.

With reference to FIGS. 4 to 6, the teaching according to the invention shall be explained with reference to a internally ventilated brake disk, the final measurements of which are about 310 mm outside diameter, 140 mm inside diameter and height 28 mm.

TFP preforms, one of which is shown in FIG. 4 and provided with the reference numeral 48 serve as base components or reinforcements for the brake disk. The preform 48, forming a friction ring in the finished brake disk, consists of individual plies or layers 50, 52, 54, 56 which are connected (e.g. stitched) to one another in the TFP technology, the lowermost layer 50 extending from a base layer or ply 58 which can be present during the further machining steps. However, this is not absolutely necessary. Moreover, the base layer 58 can also be removed beforehand.

The layers 50, 52, 54 and 56 are placed relative to the placement direction of the reinforcing fibers such that the outer layers 50, 56 contain or are constructed of radially extending reinforcing fibers and the inner layers 52, 54 of involutely extending reinforcing fibers.

The brake disk has two friction rings produced from preforms and spaced by webs, the friction rings having a basic structure which corresponds to the preform 48.

In FIGS. 4 and 5, an outer preform 60 is connected, in particular, stitched, to an inner preform 42 via webs 64, 66 to produce an internally ventilated brake disk. The structure of each preform 60, 62 corresponds, as mentioned, to the preform 48, with the restriction that the lower preform 62, i.e. the one which is formed from the lower friction layer of the brake disk, has a thickening 68 extending on the inside at which the fibers are placed so as to cross one another at an angle of about 45°. In this inner peripheral area, which is formed by the thickening 68, the respective web 64, 66 has a corresponding opening 70 so that it lies on the lower preform 62 in a form-locking manner.

The webs 64, 66 also consist of a crossing fiber structure, as shown in the transverse section of FIG. 4, in which the fibers cross at an angle of about 45°. The webs 64, 66 are thereby stitched together as a preform for a preliminary fiber volume of 48%. Furthermore, it can be seen in FIGS. 4 and 5 that layers such as fleece layers 72, 74 are arranged on the outer surfaces of the preforms 60, 62. All, i.e. the preforms 60, 62, the webs 64, 66 and the fleece layers 72, 74, are stitched together to form an overall structure and to form the subsequent brake disk.

The entire structure thus formed is then impregnated in a resin bath with phenolic resin. Lost cores, based on a highly filled polymer, are then inserted between the webs (12 in the embodiment) with aid of a workpiece locating device and secured with a clamp. A body prepared in this way is then hot-pressed at a pressure of about 4 bar and at a temperature of about 120° C. The cores are removed during a subsequent temperature treatment of about 250° C. A pyrolysis then takes place at about 1000° C., the cooling channels being firstly stabilized with reuseable graphite cores.

It should be noted that the fleeces 72, 74, which can consists of C-monofilaments and a C-containing filler, can be applied to the outer surface of the TFP preforms 60, 62 prior to or after the impregnating.

After the pyrolysis, a first machining takes place to the extent of 0.5 to 1 mm and with recessing of the fastening area of the lower friction disk formed from the preform 62 with fleece 74.

The siliconizing of the pyrolyzed structure is carried out in a capillary process at temperatures of about 1500° C.

A brake disk thus produced absorbs 50% by weight of silicon during the siliconizing. The density of the brake disk is about 1.96 g/cm³ and has an open porosity of about 4.5%.

In FIG. 7, a cross-section through a TFP preform 76 is shown merely in principle in order to clarify that it is to be constructed identically relative to its central symmetrical plane 78. Thus, plies or layers 80, 82 adjoin each side of the central symmetrical plane 78 and have an identical orientation A with respect to their fibers. Although the adjoining outer layers or plies 84, 86 exhibit a different orientation to that of the layers 80, 82, they do, however, in turn have the same ply orientation, as is made clear by the reference B.

The fibers can be radially oriented in the layers 80, 82. A circular, involute or tangential pattern can be provided in the outer layers 84, 86.

By these measures or by the symmetry with respect to the central symmetrical plane 78, it is ensured that the tribological component is warp-free and distortion-free until finished.

A symmetry can also be obtained by machining the outer layers to an extent that the desired identical fiber orientation exists.

Not only brake and clutch disks are possible as tribological components, but also friction linings, slip linings, sealing and slip rings, sliding sleeves, slides, friction bearings, ball and roller bearings, to name just a few examples.

1. A tribological fiber composite component in the form of, in particular, a brake or clutch disk employing a structure with at least one TFP preform (10, 26, 28, 36, 48, 60, 62, 76) having at least one stressable reinforcing fiber layer, the structure being stabilized by material deposition from the gas phase and/or provided with a monomer and/or polymer, hardened and pyrolyzed.

2. The fiber composite component according to claim 1, characterized in that the structure is stabilized, in particular, by CVI deposition with e.g. C, SiC, B₄C and/or Si.

3. The fiber composite component according to claim 1, characterized in that the structure is siliconized after the pyrolysis.

4. The fiber composite component according to claim 1, characterized in that the at least one TFP preform (10, 26, 28, 36, 48, 60, 62, 76) consists of areas or layers which differ from one another in their fiber volumes and/or their layer density and/or their fiber lengths and/or their fiber placement direction.

5. The fiber composite component according to claim 1, characterized in that the structure has at least two TFP preforms (26, 28, 60, 62) which are preferably constructed the same or essentially the same.

6. The fiber composite component according to claim 1, characterized in that the structure has recesses and/or channels optionally provided with cores.

7. The fiber composite component according to claim 1, characterized in that the fiber composite compound comprises a composite of at least one TFP preform (60, 62) and a layer and/or fabric and/or short fibers and/or felt and/or fleece (72, 74), 1391

8. The fiber composite component according to claim 1, characterized in that the TFP preform (60, 62) is provided with a layer (72, 74) of short fibers on the outside.

9. The fiber composite component according to claim 1, characterized in that the TFP preform (10, 26, 28, 36, 48, 60, 62, 76) has rovings with thread counts which differ from one another.

10. The fiber composite component according to claim 1, characterized in that the TFP preform (10, 26, 28, 36, 48, 60, 62, 76) has reinforcing fibers in the form of roving strands or fiber bands.

11. The fiber composite component according to claim 1, characterized in that the TFP preform (10, 26, 28, 36, 48, 60, 62, 76) has reinforcing fibers in the form of natural, glass, aramide, carbon and/or ceramic fibers.

12. The fiber composite component according to claim 1, characterized in that the TFP preform (36, 48, 76) consists of several layers (38, 40, 42, 44, 50, 52, 56, 80, 82, 84, 86) of placed reinforcing fibers, the direction of placement of the reinforcing fibers varying from one another in successive layers.

13. The fiber composite component according to claim 12, characterized in that the reinforcing fibers extend radially in a layer (38, 42, 50, 56).

14. The fiber composite component according to claim 12, characterized in that the reinforcing fibers extend in a circular manner in a layer (40, 44).

15. The fiber composite component according to claim 12, characterized in that the reinforcing fibers extend involutely in a layer (52, 54).

16. The fiber composite component according to claim 12, characterized in that the reinforcing fibers (16) extend in a layer extending from their central opening tangentially thereof.

17. The fiber composite component according to claim 1, characterized in that in a circular TFP preform (10, 26, 28, 36, 48, 60, 62, 76),the reinforcing fibers are placed in such a way that the pyrolyzed preform corresponds, or substantially corresponds, in its radial measurement to that of the preform.

18. The fiber composite component according to claim 1, characterized in that the reinforcing fibers are stitched together with polymer fibers and/or carbon fibers.

19. The fiber composite component according to claim 1, characterized in that the reinforcing fibers of the TFP preform (10, 26, 28, 36, 48, 60, 62, 76) are stitched onto a base layer (46, 58) based on carbon, aramide and/or ceramic fibers and/or a fleece.

20. The fiber composite component according to claim 1, characterized in that the structure of a clutch disk comprises at least two TFP preforms (36, 48) having the same, or essentially the same, structure.

21. The fiber composite component according to claim 1, characterized in that the TFP preform (48, 76) consists of several layers (50, 52, 54, 80, 82, 84, 86), the layers being placed symmetrically or substantially symmetrically with respect to the central symmetrical plane (78) of the TFP preform in their fiber orientation.

22. The fiber composite component according to claim 1, characterized in that the TFP preform (36, 48) consists of at least two layers (38, 40, 42, 44, 50, 52, 54, 56) or plies, one of the layers or plies (38, 42) being built from radially placed reinforcing fibers and the remaining layer or ply (40, 44) of reinforcing fibers placed in a circular manner.

23. The fiber composite component according to claim 1, characterized in that layers or plies (38, 40, 42, 44, 50, 52, 54, 56) of the TFP preform are each stitched together with the base layer (46, 58).

24. The fiber composite component according to claim 1, characterized in that the TFP preform (48, 76) has fibers of the same or essentially the same orientation in its outer surfaces or layers (50, 56, 84, 86).

25. The fiber composite component according to claim 1, characterized in that the structure of a brake disk consists of at least two TFP preforms (26, 28, 60, 62) spaced from one another and which are connected to one another by webs (30, 32, 34, 44, 46) formed from reinforcing fibers.

26. The fiber composite component according to claim 1, characterized in that the TFP preform (62) has a thickening (68) formed by reinforcing fibers in the region of a force input point.

27. The fiber composite component according to claim 26, characterized in that the reinforcing fibers are placed so as to cross one another in the thickening (68).

28. The fiber composite component according to claim 25, characterized in that the reinforcing fibers are placed so as to cross one another in the webs (64, 66).

29. The fiber composite component according to claim 1, characterized in that the TFP preform (60, 62) has a fleece layer (72, 74) on its free outer surfaces.
